(19) United States
(12) Patent Application Publication
(10) Pub. No.: US 2013/0340527 A1
(43) Pub. Date: Dec. 26, 2013

(54) ACCELERATION SENSOR

(71) Applicant: Murata Manufacturing Co., Ltd., (US)

(72) Inventors: Takahiro KONISHI, Nagaokakyo-shi (JP); Kazuhiro YOSHIDA, Nagaokakyo-shi (JP)

(73) Assignee: Murata Manufacturing Co., Ltd., Nagaokakyo-shi (JP)

(21) Appl. No.: 13/693,256

(22) Filed: Dec. 4, 2012

Related U.S. Application Data
(63) Continuation of application No. PCT/JP2011/063099, filed on Jun. 8, 2011.

(30) Foreign Application Priority Data
Jun. 11, 2010 (JP) 2010-133646

(51) Int. Cl. G01P 15/12

(52) U.S. Cl. CPC G01P 15/123
USPC 73/514.33

(57) ABSTRACT

An acceleration sensor with improved impact resistance includes a beam portion connected to a supporting portion at a base side and connected to a weight portion at a top side. The beam portion has a T-shaped cross-section, and piezoresistors are located on an upper surface of the beam portion. The weight portion connects to a top of the beam portion and is arranged inside the supporting portion. A C-shaped slit is provided between the weight portion and the supporting portion so as to surround the weight portion. The weight portion includes an extended portion in which an end of a top surface layer on a side facing the beam portion extends out toward the beam portion beyond an end of the supporting substrate layer on a side facing the beam portion.

### BACKGROUND OF THE INVENTION

1. Field of the Invention

The present invention relates to an acceleration sensor that detects external stress using piezoresistors.

2. Description of the Related Art

In recent years, acceleration sensors have been used in airbags, camera's image stabilizer mechanisms, etc. to detect acceleration. As such kinds of acceleration sensors, for example, there is a known sensor that is fabricated by thinning a silicon wafer to form a beam and further forming piezoresistors on the beam (for example, see Japanese Unexamined Patent Application Publication No. 8-160066). Below, an acceleration sensor disclosed in Japanese Unexamined Patent Application Publication No. 8-160066 is described based on FIGS. 1A and 1B.

FIG. 1A is a plan view illustrating an acceleration sensor 1 disclosed in Japanese Unexamined Patent Application Publication No. 8-160066, and FIG. 1B is a cross-sectional view along a line A-A of FIG. 1A. FIG. 2 is an enlarged perspective view of principle part and illustrates a model of an acceleration sensor 1 formed by following FIGS. 1A and 1B. The acceleration sensor 1 includes a supporting portion 10, a beam portion 11, and a weight portion 14.

The acceleration sensor 1 is formed by use of a SOI (Silicon On Insulator) substrate 90. Accordingly, the acceleration sensor 1 includes a top surface layer 91 arranged on a top surface side, a supporting substrate layer 93 that is provided on a back surface side of the top surface layer 91 and forms a back surface layer, and an intermediate insulation layer 92 arranged between the top surface layer 91 and the supporting substrate layer 93. The supporting portion 10 is arranged on an outer circumferential side of the acceleration sensor 1 and formed, for example, in a substantially rectangular frame shape. The supporting portion 10 is formed from the top surface layer 91, the intermediate insulation layer 92, and the supporting substrate layer 93. Furthermore, the beam portion 11 is provided inside the supporting portion 10 in such a way that the beam portion 11 projects out from a left-hand side to a right-hand side in a lateral direction in FIG. 1A.

The beam portion 11 connects to the supporting portion 10 at a base side and connects to the weight portion 14 at a top side. Furthermore, the beam portion 11 is formed so as to have a cross-section of a letter “T” shape. The beam portion 11 is formed from a plate portion 12A formed of the top surface layer 91 and a bridge support portion 12B formed from the supporting substrate layer 93 and the intermediate insulation layer 92.

The weight portion 14 connects to a top of the beam portion 11 and is arranged inside the supporting portion 10. The weight portion 14 is formed from the top surface layer 91, the intermediate insulation layer 92, and the supporting substrate layer 93. Furthermore, a slit 13 is provided between the weight portion 14 and the supporting portion 10. The slit 13 has a shape that resembles a letter “C” shape and surrounds the weight portion 14. According to such an arrangement, a gap is formed between the weight portion 14 and the supporting portion 10, and the beam portion 11 supports the weight portion 14 in such a way that the weight portion 14 is allowed to displace in an X direction. Four piezoresistors R are formed on an upper surface of the beam portion 11. The four piezoresistors R form a detection circuit.

When the acceleration sensor 1 is accelerated in the X direction in the foregoing structure, the weight portion 14 swings within a horizontal plane about the beam portion 11 that serves as a center of swing due to an inertial force (external stress) applied to the weight portion 14, causing strain deformation of the beam portion 11 and inducing stress in the piezoresistors R on the beam portion 11. Accordingly, resistance values of the piezoresistors R change in response to the inertial force (external stress) caused by the acceleration. Thus, a voltage of a detection signal output from the detection circuit including the piezoresistors R also changes in response to the resistance values of the piezoresistors R. Thus, the resistance values of the piezoresistors R may be obtained by using the voltage of a detection signal output from the detection circuit including the piezoresistors R. Accordingly, the acceleration (inertial force) may be detected by using these resistance values.

However, the acceleration sensor 1 illustrated in the foregoing Japanese Unexamined Patent Application Publication No. 8-160066 has a structure in which the stress tends to concentrate on the beam portion 11 when an impact occurs and acceleration in the X direction is applied. Thus, when an excessive impact occurs or impact is repeated, there is a possibility that the beam portion 11 may be damaged.

It is possible to employ a method for improving impact resistance by thickening a width of the bridge support portion 12B of the beam portion 11. However, in such a method, there are shortcomings such as a decrease in sensitivity and a shift in resonance frequency of the acceleration sensor 1.

### SUMMARY OF THE INVENTION

Accordingly, preferred embodiments of the present invention provide an acceleration sensor whose impact resistance is improved without changing a resonance frequency or reducing sensitivity of the acceleration sensor.

An acceleration sensor according to a preferred embodiment of the present invention includes a weight portion, a supporting portion, a beam portion that connects an end of the weight portion to the supporting portion and in which strain deformation occurs in response to an external stress, and a piezoresistor that is located on the beam portion and detects the external stress, wherein the weight portion, the supporting portion, and the beam portion include a plurality of layers, one of the plurality of layers of the beam portion is a piezo formation layer including the piezoresistor, and the weight portion includes an extended portion in which an end of a first layer that is a same layer as the piezo formation layer extends out toward the beam portion beyond an end of a second layer of the plurality of layers, the end of the first layer and the end of the second layer being on sides facing the beam portion.

In such a structure, the weight portion includes the extended portion. Thus, when an impact occurs and acceleration in the X direction is applied, the stress disperses toward the beam portion from a border line between the beam portion and the weight portion. In such a structure, experiments indicate that the impact resistance is improved over the acceleration sensor 1 of Japanese Unexamined Patent Application Publication No. 8-160066. Furthermore, in such a structure, experiments indicate that the sensor sensitivity and the resonance frequency are not different from those of the acceleration sensor 1 of Japanese Unexamined Patent Application Publication No. 8-160066.

Thus, according to such a structure, the impact resistance of an acceleration sensor may be improved without changing the resonance frequency or reducing the sensitivity of the acceleration sensor.

The weight portion, the supporting portion, and the beam portion are preferably defined by a SOI substrate, and the piezo formation layer preferably is a semiconductor film layer of the SOI substrate.

An extension length of the extended portion is preferably equal to or less than about 10 μm, for example.

The beam portion connects both ends of the weight portion to the supporting portion.

In such a structure, the acceleration sensor preferably is a so-called double-supported beam type.

According to various preferred embodiments of the present invention, the impact resistance of an acceleration sensor is significantly improved without changing the resonance frequency or reducing the sensitivity of the acceleration sensor.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1A is a plan view illustrating an acceleration sensor 1 disclosed in Japanese Unexamined Patent Application Publication No. 8-160066. FIG. 1B is a cross-sectional view along a line A-A of FIG. 1A.

FIG. 2 is an enlarged perspective view of a principle part and illustrates a model of an acceleration sensor 1 shown in FIGS. 1A and 1B.

FIG. 3 is a perspective view of an acceleration sensor 3 according to a preferred embodiment of the present invention.

FIG. 4 is a circuit diagram of a detection circuit 7 of an acceleration sensor 3 according to a preferred embodiment of the present invention.

FIG. 5 is an enlarged perspective view of a principle portion and illustrates an acceleration sensor 3 according to a preferred embodiment of the present invention.

FIG. 6A is a side view of a beam portion 31 viewed from an arrow P illustrated in FIG. 5. FIG. 6B is a side view of a weight portion 34 viewed from an arrow Q illustrated in FIG. 5. FIG. 6C is a bottom view of the beam portion 31 and the weight portion 34.

FIG. 7 is an enlarged perspective view of a principle portion and illustrates an acceleration sensor 2 that is a comparative example.

FIG. 8A is a diagram illustrating calculation results of stress and resonance frequency for respective models, which are calculated by a finite element method (FEM), assuming that an acceleration of 1 G in a X-direction is applied to respective Models. FIG. 8B is a diagram illustrating calculation results of Models other than Model 1 in percent figures based on the calculation result of Model 1 illustrated in FIG. 8A.

FIG. 9 is a graph illustrating relationships between the stress and an edge position, and the resonance frequency and the edge position illustrated in FIG. 8B.

FIG. 10 is a graph illustrating a relationship between the resonance frequency and the edge position illustrated in FIG. 8B.

FIG. 11A is an enlarged perspective view illustrating an area where maximum stress is induced in Model 1. FIG. 11B is an enlarged perspective view illustrating an area where maximum stress is induced in Model 2-2. FIG. 11C is an enlarged perspective view illustrating an area where maximum stress is induced in Model 3-2.

FIG. 12 is a graph illustrating relationships between positions on top surfaces of beam portions 11, 21, 31 and stresses that are induced at the corresponding positions when applying an acceleration of 1 G in an X-direction to respective Models.

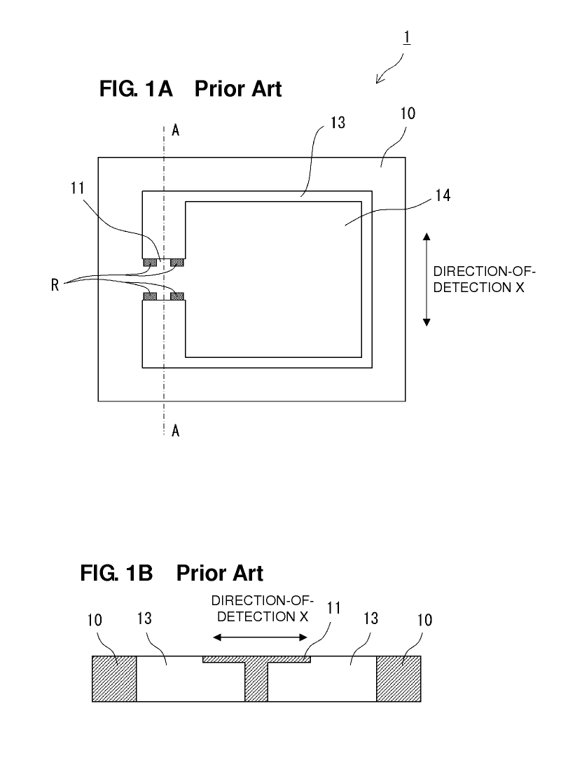

### DETAILED DESCRIPTION OF THE PREFERRED EMBODIMENTS

Acceleration sensors according to preferred embodiments of the present invention are described with reference to the drawings. An acceleration sensor according to various preferred embodiments of the present invention may be used, for example, in airbags, camera's image stabilizer mechanisms, etc. to detect acceleration.

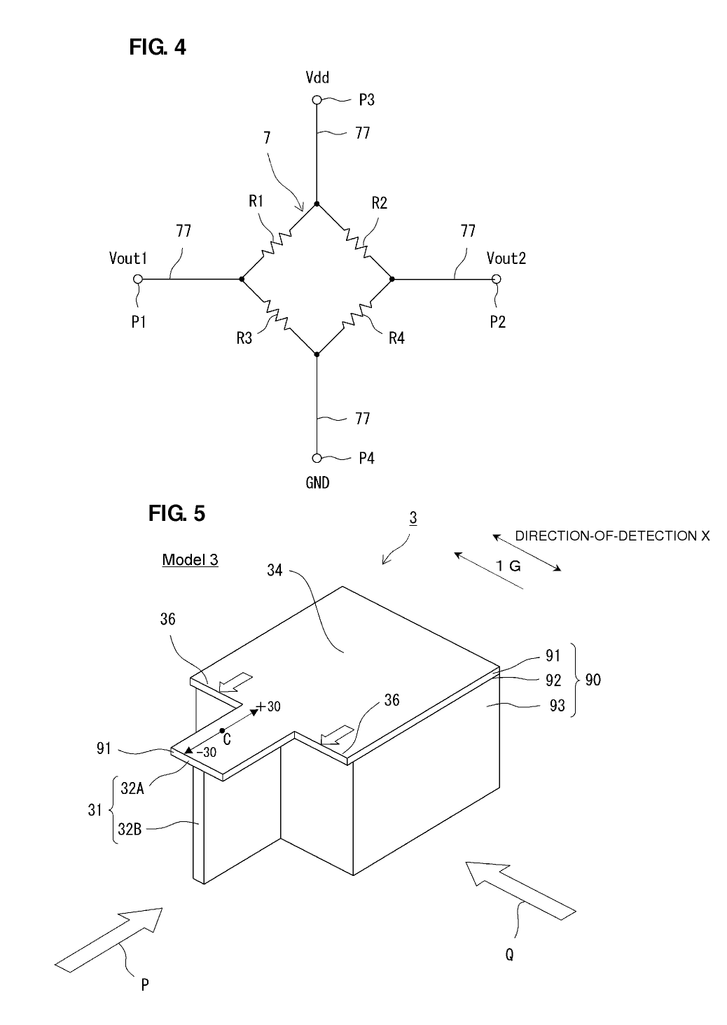

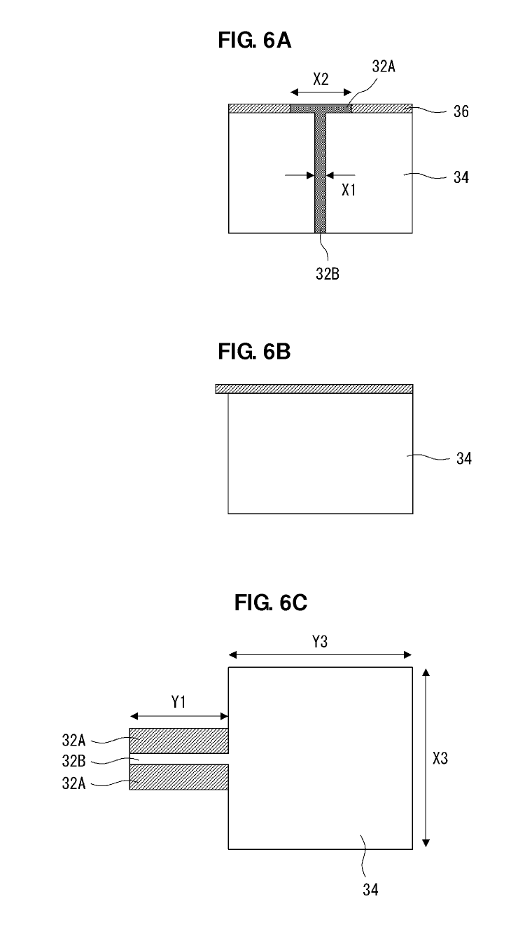

FIG. 3 is a perspective view illustrating an acceleration sensor 3 according to a preferred embodiment of the present invention. FIG. 4 is a circuit diagram of a detection circuit 7 of the acceleration sensor 3 according to a preferred embodiment of the present invention. FIG. 5 is an enlarged perspective view of a principle portion and illustrates the acceleration sensor 3 according to a preferred embodiment of the present invention. FIG. 6A is a side view of a beam portion 31 viewed from an arrow P illustrated in FIG. 5. FIG. 6B is a side view of a weight portion 34 viewed from an arrow Q illustrated in FIG. 5. FIG. 6C is a bottom view of the beam portion 31 and the weight portion 34.

The acceleration sensor 3 includes a supporting portion 30, the beam portion 31, and the weight portion 34. The detection circuit 7 illustrated FIG. 4 is preferably located in the supporting portion 30 and the beam portion 31.

As illustrated in FIG. 3 to FIG. 6C, the acceleration sensor 3 preferably includes, for example, an SOI (Silicon On Insulator) substrate 90. Accordingly, the acceleration sensor 3 includes a top surface layer 91 arranged on a top surface side, a supporting substrate layer 93 that is provided on a back surface side of the top surface layer 91 and defines a back surface layer, and an intermediate insulation layer 92 arranged between the top surface layer 91 and the supporting substrate layer 93. Here, both the top surface layer 91 and the supporting substrate layer are preferably formed by use of silicon materials, and the intermediate insulation layer 92 is preferably formed by use of an insulation material such as, for example, silicon dioxide (SiO₂), for example. Thus, the top surface layer 91 is a semiconductor thin film layer of the SOI substrate 90.

The supporting portion 30 is arranged on an outer circumferential side of the acceleration sensor 3 and preferably has, for example, a substantially rectangular frame shape. The supporting portion 30 is defined by the top surface layer 91, the intermediate insulation layer 92, and the supporting substrate layer 93. Furthermore, the beam portion 31 is provided inside the supporting portion 30 in such a way that the beam portion 31 projects out from a near side to a far side in a lateral direction (Y direction) in FIG. 3.

The beam portion 31 connects to the supporting portion 30 at a base side and connects to the weight portion 34 at a top side. Furthermore, the beam portion 31 preferably has a cross section of a letter “T” shape, and is defined by a plate portion 32A including the top surface layer 91 and a bridge support portion 32B defined by the supporting substrate layer 93 and the intermediate insulation layer 92. Thus, strain deformation easily occurs in the beam portion 31 along a lateral direction (X direction) in FIG. 3.

The weight portion 34 connects to a top of the beam portion 31 and is arranged inside the supporting portion 30. The weight portion 34 is defined by the top surface layer 91, the intermediate insulation layer 92, and the supporting substrate layer 93. Furthermore, a slit 33 is provided between the weight portion 34 and the supporting portion 30. The slit 33 has a shape that preferably resembles a letter “C” and surrounds the weight portion 34. According to such an arrangement, a gap is provided between the weight portion 34 and the supporting portion 30, and the beam portion 31 supports the weight portion 34 in such a way that the weight portion 34 is allowed to displace in the X direction. Furthermore, the weight portion 34 includes an extended portion 36 in which the top surface layer 91 extends out toward the beam portion 31 beyond the supporting substrate layer 93.

Here, non-limiting examples of dimensions of the respective portions of the beam portion 31 and the weight portion 34 are as follows (see FIGS. 6A-6C):

Width X1 of the bridge support portion 32B=10 μm

Length Y1 of the bridge support portion 32B=80 μm

Width X2 of the plate portion 32A=50 μm

Width X3 of a lower surface of the weight portion 34=150 μm

Length Y3 of the lower surface of the weight portion 34=150 μm

The detection circuit 7 preferably includes, as illustrated in FIG. 3 and FIG. 4, four piezoresistors R1-R4, wiring portions 77, and four electrodes P1-P4, for example. The detection circuit 7 is provided on the top surface side of the supporting portion 30 and the beam portion 31, and covered by an insulation film such as, for example, silicon oxide, silicon nitride, etc., for example.

The piezoresistors R1-R4 are preferably formed on an upper surface of the beam portion 31, for example, by diffusing (doping) a p-type impurity into the upper surface of the beam portion 31. In other words, the top surface layer 91 that defines the beam portion 31 is a piezo formation layer. Furthermore, the piezoresistors R2 and R4 are connected in series, and the piezoresistors R1 and R3 are also connected in series. Furthermore, a series-connected circuit of the piezoresistors R2 and R4 and a series-connected circuit of the piezoresistors R1 and R3 are connected in parallel to each other. According to the above, the detection circuit 7 defines a Wheatstone bridge circuit illustrated in FIG. 4 and improves detection sensitivity of the acceleration sensor 3.

Furthermore, the series-connected circuit of the piezoresistors R1 and R3 connects to a drive electrode P3, from which a drive voltage Vdd is supplied, at one end (resistor R1 side), and to a ground electrode P4 for grounding (GND) at the other end (resistor R3 side). The series-connected circuit including the piezoresistors R2 and R4 connects to the drive electrode P3, from which the drive voltage Vdd is supplied, at one end (resistor R2 side), and to the ground electrode P4 for grounding (GND) at the other end (resistor R4 side). Furthermore, a connecting point between the piezoresistors R1 and R3 connects to an output electrode P1 to output a first detection signal Vout1, and a connecting point between the piezoresistors R2 and R4 connects to an output electrode P2 to output a second detection signal Vout2.

The electrodes P1-P4 preferably each include, for example, an electrode pad that uses an electrically conductive metal material, and is provided on the top surface of the supporting portion 30.

The wiring portions 77 are provided on the top surface sides of the supporting portion 30 and the beam portion 31. The wiring portions 77 connect in between the piezoresistors R1-R4, and connect the piezoresistors R1-R4 and their respective electrodes P1-P4.

Note that it is preferable to arrange the wiring portions 77 in such a way that all the wiring portions 77 have a same resistance value as each other so as to balance the bridge circuit, for example, by making their line lengths equal to each other.

When the acceleration sensor 3 with the foregoing structure is accelerated in the X direction, the weight portion swings within a horizontal plane about the beam portion 31 that serves as a center of swing due to an inertial force (external stress) applied to the weight portion 34, causing strain deformation of the beam portion 31 and inducing stress in the piezoresistors R1-R4 on the beam portion 31. Accordingly, resistance values of the piezoresistors R1-R4 change in response to the inertial force (external stress) caused by the acceleration. Thus, voltages of the first detection signal Vout1 and the second detection signal Vout2 output from the output electrodes P1 and P2, respectively, change in response to the resistance values of the piezoresistors R1-R4. At this stage, the resistance values of the piezoresistors R1-R4 may be obtained by use of the voltages of the first and second detection signals Vout1 and Vout2 output from the output electrodes P1 and P2. Thus, the acceleration (inertial force) may be detected by detecting the first and second detection signals Vout1 and Vout2 output from the output electrodes P1 and P2.

Next, an acceleration sensor 2 that serves as a comparison example is described.

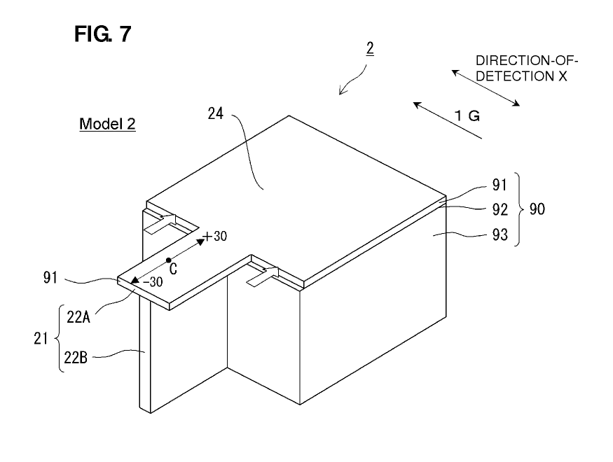

FIG. 7 is an enlarged perspective view of a principle portion and illustrates the acceleration sensor 2. The acceleration sensor 2 is different from the acceleration sensor 3 illustrated in FIG. 5 in a weight portion 24. The weight portion has a shape opposite to that of the weight portion 34 including the extended portion 36 (see FIG. 5), and the shape is such that an end of the top surface layer 91 on a side facing the beam portion 21 recedes away from the beam portion 21 beyond an end of the supporting substrate layer 93 on a side facing the beam portion 21.

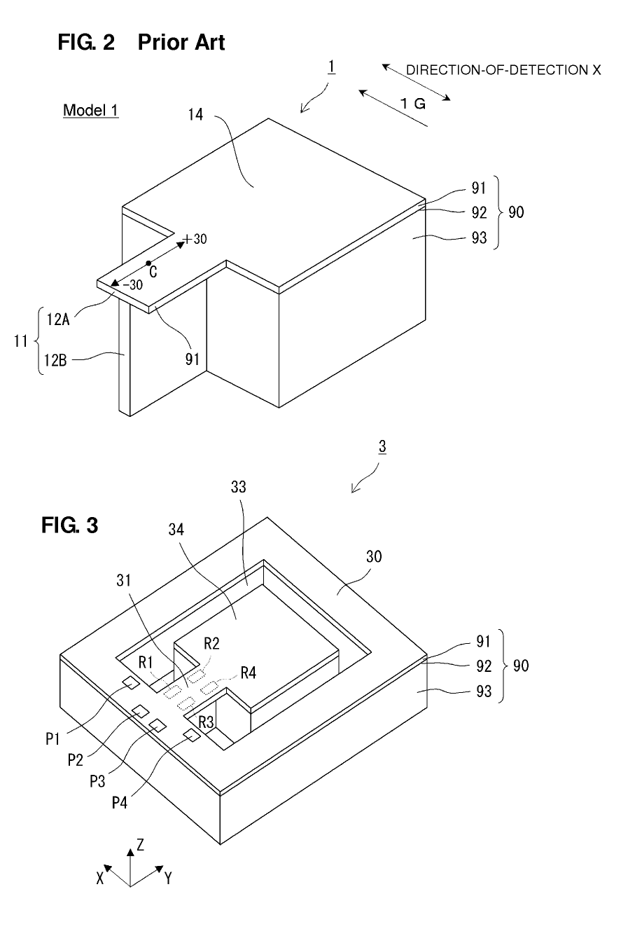

Next, impact resistance, sensor sensitivity, and a resonance frequency of the acceleration sensor 3 are described while comparing with the acceleration sensors 1 and 2. In the following description, the acceleration sensors 1, 2, 3 are referred to as Models 1, 2, and 3, respectively. Here, differences among Models 1, 2, and 3 are summarized as follows. The weight portion 14 of Model 1 illustrated in FIG. 2 has a shape such that ends of the top surface layer 91 and the supporting substrate layer 93 on sides facing the beam portion 11 are aligned to each other. The weight portion 24 of Model 2 illustrated in FIG. 7 has the shape such that the end of the top surface layer 91 on the side facing the beam portion 21 recedes back behind the end of the supporting substrate layer 93 on the side facing the beam portion 21. The weight portion 34 of Model 3 illustrated in FIG. 5 has a shape including the extended portion 36 in which an end of the top surface layer 91 on a side facing the beam portion 31 extends out toward the beam portion 31 beyond an end of the supporting substrate layer 93 on a side facing the beam portion 31. Otherwise, the remaining structure is common to all models described above.

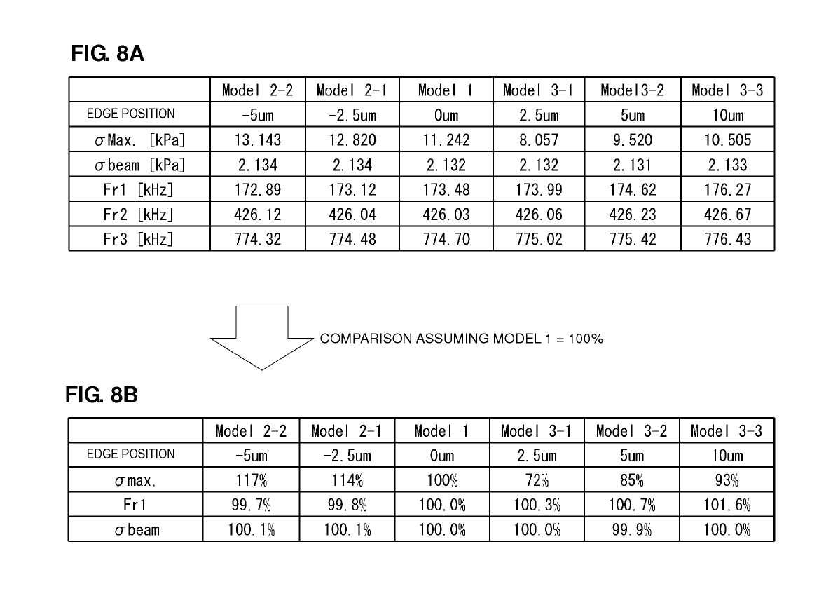

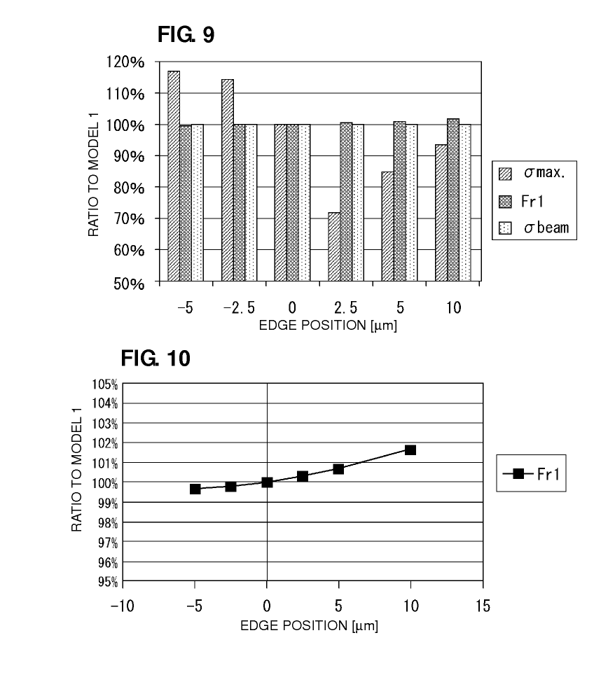

FIG. 8A is a diagram illustrating calculation results of the stress and the resonance frequency of the respective Models, which are calculated by a finite element method (FEM), assuming that an acceleration of 1 G in the X-direction is applied to the respective Models. FIG. 8B is a diagram illustrating calculation results of Models other than Model 1 in percent figures based on the calculation result of Model 1 illustrated in FIG. 8A. FIG. 9 is a graph illustrating relationships between the stress and an edge position, and the resonance frequency and the edge position illustrated in FIG. 8B. FIG. 10 is a graph illustrating a relationship between the edge position and the resonance frequency illustrated in FIG. 8B. Here, Model 2-1 illustrated in FIGS. 8A and 8B is an acceleration sensor having a shape such that the end of the top surface layer 91 on the side facing the beam portion 21 recedes away from the beam portion 21 by about 2.5 μm beyond the end of the supporting substrate layer 93 on the side facing the beam portion 21. Model 2-2 is an acceleration sensor having a shape such that the end of the top surface layer 91 on the side facing the beam portion 21 recedes away from the beam portion 21 by about 5 μm beyond the end of the supporting substrate layer 93 on the side facing the beam portion 21. Similarly, Model 3-1 is an acceleration sensor having a shape including the extended portion 36 in which the end of the top surface layer 91 on the side facing the beam portion 31 extends out toward the beam portion 31 by about 2.5 μm beyond the end of the supporting substrate layer 93 on the side facing the beam portion 31. Model 3-2 is an acceleration sensor having a shape including the extended portion 36 in which the end of the top surface layer 91 on the side facing the beam portion 31 extends out toward the beam portion 31 by about 5 μm beyond the end of the supporting substrate layer 93 on the side facing the beam portion 31. Model 3-3 is an acceleration sensor having a shape including the extended portion 36 in which the end of the top surface layer 91 on the side facing the beam portion 31 extends out toward the beam portion 31 by about 10 μm beyond the end of the supporting substrate layer 93 on the side facing the beam portion 31. The σMax illustrated in FIGS. 8A and 8B represents the maximum stress that is induced in each Model when an acceleration of 1 G in the X direction is applied. The σbeam represents the stresses that are induced on the top surfaces of the beam portions 11, 21, and 31 when applying an acceleration of 1 G in the X-direction. The Fr1-Fr3 represent the resonance frequencies of the respective Models. Here, the σMax corresponds to a value indicating the impact resistance, and the σbeam corresponds to a value indicating the sensor sensitivity.

The calculation results illustrated in FIG. 8-FIG. 10 indicate that the σMax (impact resistance) is improved in Models 3-1 to 3-3 that have the shape including the extended portion 36 in which the end of the top surface layer 91 on the side facing the beam portion 31 extends out toward the beam portion 31 beyond the end of the supporting substrate layer 93 on the side facing the beam portion 31. More specifically, it becomes clear that Model 3-1 has the most superior impact resistance. Furthermore, it also becomes clear that the sensor sensitivities and the resonance frequencies of Models 3-1 to 3-3 are no different from those of Model 1.

Furthermore, the impact resistance of the acceleration sensor 3 is described while comparing with the acceleration sensors 1 and 2.

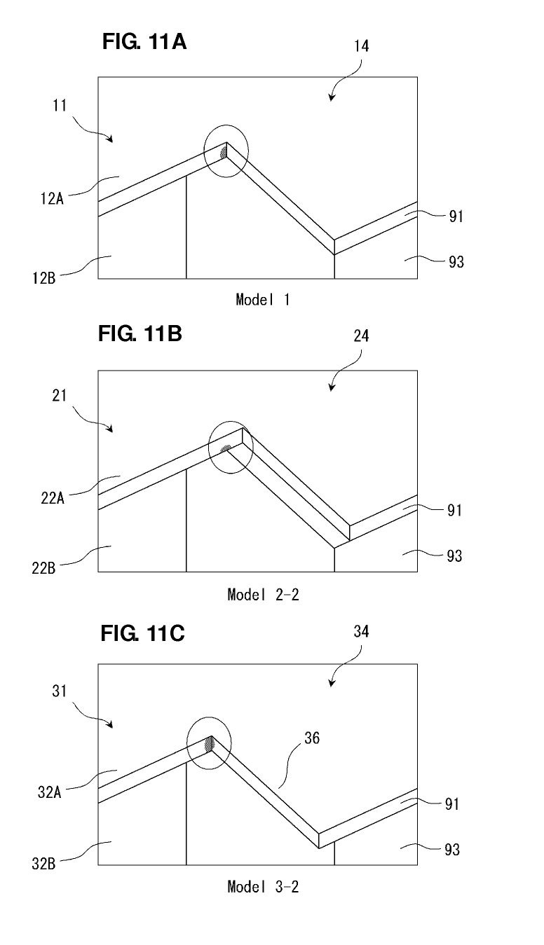

FIG. 11A is an enlarged perspective view illustrating an area where the maximum stress is induced in Model 1. FIG. 11B is an enlarged perspective view illustrating an area where the maximum stress is induced in Model 2-2. FIG. 11C is an enlarged perspective view illustrating an area where the maximum stress is induced in Model 3-2. Here, the areas illustrated in FIGS. 11A-11C, in which the maximum stress is induced, are provided by calculation using a FEM.

As illustrated in FIG. 11A, in Model 1, the maximum stress is concentrated on a border line between the beam portion 11 and the weight portion 14. Furthermore, as illustrated in FIG. 11B, in Model 2-2, the maximum stress is concentrated on a single point where the beam portion 21 and an edge of the supporting substrate layer 93 of the weight portion 24 intersect.

However, as illustrated in FIG. 11C, in Model 3-2, the maximum stress disperses toward the beam portion 31 from a border line between the beam portion 31 and the weight portion 34, and the area where the maximum stress is induced is the largest among these Models.

Thus, the calculation results illustrated in FIGS. 11A-11C indicate that Model 3-2 having the shape including the extended portion 36 in the weight portion 34, in which the end of the top surface layer 91 on the side facing the beam portion 31 extends out toward the beam portion 31 beyond the end of the supporting substrate layer 93 on the side facing the beam portion 31, has the most superior impact resistance among these Models. Similar calculation results are obtained when Model 1, Model 2-1, and Model 3-1 are calculated by a FEM. That is, it becomes clear that Model 3-1 has the most superior impact resistance among these Models.

As described above, according to the acceleration sensor 3 of the present preferred embodiment, the impact resistance is significantly improved without reducing the sensitivity or changing the resonance frequency of the acceleration sensor.

Furthermore, the sensitivity of the acceleration sensor 3 is described while comparing with the acceleration sensors 1 and 2.

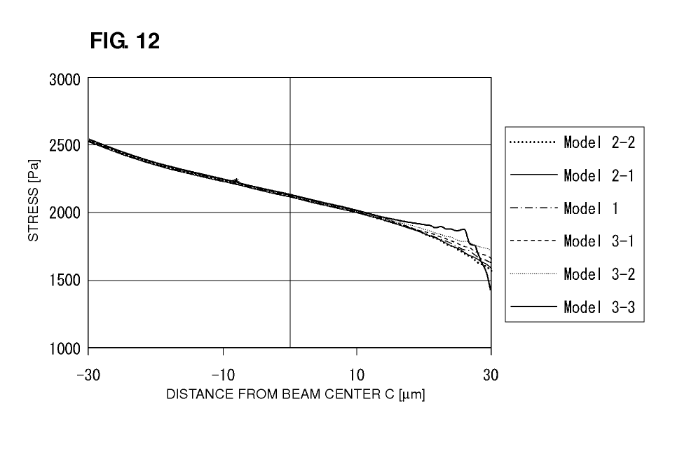

FIG. 12 is a graph illustrating relationships between positions on top surfaces of beam portions 11, 21, 31 and stresses that are induced at the corresponding positions when applying an acceleration of 1 G in the X-direction to the respective Models. Here, the induced stress at each position is calculated by a FEM. In Model 1 illustrated in FIG. 2, all the positions are preferably within a range between about +30 μm and about −30 μm from a reference point C that is a center of an arrow line, which is extending in the longer direction of the beam portion 11 and positioned at about 2 μm inside of an end of the beam portion 11 in the shorter direction thereof. In Models 2 and 3, the stress is calculated at the same positions as in Model 1 (see FIG. 5, FIG. 7).

The calculation results illustrated in FIG. 12 indicate that the sensor sensitivities of Model 3-1 and Model 3-2 are substantially no different from that of Model 1.

However, the calculation results also indicate that the sensor sensitivity of Model 3-3 is improved at the positions in between about +20 μm and about +25 μm compared to the other Models and declines below the other Models at the position of about +30 μm.

Accordingly, an extension length of the extended portion 36 is preferably equal to or less than about 10 μm, for example.

In the foregoing preferred embodiment, examples are described for a case where the acceleration sensor 3 of a cantilever type is preferably used. Alternatively, an acceleration sensor of a double-supported beam type may be used.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An acceleration sensor comprising:
a weight portion;
a supporting portion;
a beam portion that connects an end of the weight portion to the supporting portion and in which strain deformation occurs in response to external stress; and
a piezoresistor located on the beam portion and arranged to detect the external stress; wherein
the weight portion, the supporting portion, and the beam portion are defined by a plurality of layers;
one of the plurality of layers of the beam portion is a piezo formation layer in which the piezoresistor is provided; and
the weight portion includes an extended portion in which an end of a first one of the plurality of layers that is a same layer as the piezo formation layer extends out toward the beam portion beyond an end of a second one of the plurality of layers, the end of first layer and the end of the second layer being on sides facing the beam portion.

2. The acceleration sensor according to claim 1, wherein the weight portion, the supporting portion, and the beam portion are defined by a SOI substrate, and the piezo formation layer is a semiconductor film layer of the SOI substrate.

3. The acceleration sensor according to claim 1, wherein an extension length of the extended portion is equal to or less than about 10 μm.

4. The acceleration sensor according to claim 2, wherein an extension length of the extended portion is equal to or less than about 10 μm.

5. The acceleration sensor according to claim 1, wherein the beam portion connects both ends of the weight portion to the supporting portion.

6. The acceleration sensor according to claim 2, wherein the beam portion connects both ends of the weight portion to the supporting portion.

7. The acceleration sensor according to claim 3, wherein the beam portion connects both ends of the weight portion to the supporting portion.

8. The acceleration sensor according to claim 4, wherein the beam portion connects both ends of the weight portion to the supporting portion.

9. The acceleration sensor according to claim 1, wherein the plurality of layers include a top surface layer, a supporting substrate layer defining a back surface layer, and an intermediate insulation layer arranged between the top surface layer and the supporting substrate layer.

10. The acceleration sensor according to claim 9, wherein the top surface layer and the supporting substrate layer are made of silicon material and intermediate insulation layer is made of insulation material.

11. The acceleration sensor according to claim 9, wherein the top surface layer, the supporting substrate layer and the intermediate insulation layer define the supporting portion.

12. The acceleration sensor according to claim 1, wherein the beam portion is connected to the supporting portion at a base side and is connected to the weight portion at a top side.

13. The acceleration sensor according to claim 1, wherein the beam portion has a T-shaped cross section.

14. The acceleration sensor according to claim 1, wherein the beam portion includes a plate portion including a top surface layer and a bridge support portion including a supporting substrate layer and an intermediate insulation layer.

15. The acceleration sensor according to claim 1, wherein the weight portion connects to a top of the beam portion and is arranged inside the supporting portion.

16. The acceleration sensor according to claim 1, wherein the weight portion includes a top surface layer, an intermediate insulation layer, and a supporting substrate layer.

17. The acceleration sensor according to claim 1, further comprising a slit provided between the weight portion and the supporting portion.

18. The acceleration sensor according to claim 17, wherein the slit is C-shaped.

19. The acceleration sensor according to claim 17, wherein the slit surrounds the weight portion.

20. The acceleration sensor according to claim 17, wherein a gap is provided between the weight portion and the supporting portion, and the beam portion supports the weight portion in such a way that the weight portion is allowed to move in a predetermined direction.
